(19) United States
(12) Patent Application Publication
(10) Pub. No.: US 2007/0261084 A1
(43) Pub. Date: Nov. 8, 2007

(54) Interactive event display system for tracking items during events

(76) Inventors: Emmitt J. Smith III, Dallas, TX (US); Victor J. Dupuy II, Colleyville, TX (US); Thomas K. Lew, Flower Mound, TX (US)

Correspondence Address: Mr. Christopher John Rourk;Jackson Walker LLP, 901 Main Street, Suite 6000, DALLAS, TX, 75202, US

(21) Appl. No.: 11/430,126

(22) Filed: May 8, 2006

(51) Int. Cl. H04N 7/173; H04N 5/445

(52) U.S. Cl. 725/86; 725/37

(57) ABSTRACT

A system for displaying information to allow an observer at an event to obtain event-related data of specific interest, such as a player's individual statistics, using a pre-existing event general purpose display, such as a scoreboard, is provided. The system includes an information control system receiving contact information, such as a phone number or web address. The information control system formats the contact information to be compatible with the pre-existing event general purpose display, and provides the contact information to the pre-existing event display to allow the observer seeking the event-related data of specific interest to contact the information control system. A display control system receives the contact information and provides the contact information to the general purpose display. An information interface system establishes a communications channel with the observer, such as by receiving a telephone call from the user and generating audio prompts. The information interface system retrieves requested event-related data of specific interest from a data source, such as based on user-entered responses to the prompts, and formats the requested event-related data of specific interest for transmission to the observer, such as for transmission over the telephone by text-to-speech conversion. The information interface system then transmits the event-related data of specific interest to the observer.

### FIELD OF THE INVENTION

The present invention relates generally to an event display system such as a scoreboard, and more particularly to an interactive event display system that allows observers at events to obtain information on items being used in the event and other event details that are not of general interest and would not be continuously displayed on the scoreboard.

### BACKGROUND OF THE INVENTION

Scoreboards, displays for translating words in a performance in a foreign language, and other types of event display systems for use during a live event are known in the art. Such displays provide pre-determined information to a viewer, but do not include any interactive content. As such, these systems allow an operator to enter data for display during the event, but do not provide any way for viewers to interact with the information.

Such event displays can be distinguished from television “infomercials” or other television marketing programs, where the primary purpose of the program is to provide information about the product that is being sold and further inform the user of where they can purchase the product. The primary purpose of an event display is provide information of general interest about the event. Thus, if a viewer wants to obtain information about an item, event participant, or other feature of the event, they must research such information independently of the event, and typically after the event has concluded.

### SUMMARY OF THE INVENTION

Therefore, an event display system is needed where a viewer can receive information that allows them to obtain additional information about items being used in the event while the event is transpiring, and where the primary function of the event display system is to provide information of general interest about the event and not to provide detailed information about specific items, participants, actors, or other details related to the event.

In one exemplary embodiment, a system for displaying information to allow an observer at an event to obtain event-related data of specific interest, such as a player's individual statistics, using a pre-existing event general purpose display, such as a scoreboard, is provided. The system includes an information control system receiving contact information, such as a phone number or web address. The information control system formats the contact information to be compatible with the pre-existing event general purpose display, and provides the contact information to the pre-existing event display to allow the observer seeking the event-related data of specific interest to contact the information control system. A display control system receives the contact information and provides the contact information to the general purpose display. An information interface system establishes a communications channel with the observer, such as by receiving a telephone call from the user and generating audio prompts. The information interface system retrieves requested event-related data of specific interest from a data source, such as based on user-entered responses to the prompts, and formats the requested event-related data of specific interest for transmission to the observer, such as for transmission over the telephone by text-to-speech conversion. The information interface system then transmits the event-related data of specific interest to the observer.

Those skilled in the art will further appreciate the advantages and superior features of the invention together with other important aspects thereof on reading the detailed description that follows in conjunction with the drawings.

### BRIEF DESCRIPTION OF THE SEVERAL VIEWS OF THE DRAWINGS

FIG. 1 is a diagram of a system for displaying data on an event display that allows a user to obtain detail data during an event in accordance with an exemplary embodiment of the present invention;

FIG. 2 is a diagram of a system for controlling an event display to allow a user to obtain detail data in accordance with an exemplary embodiment of the present invention;

FIG. 3 is a diagram of a system for controlling information requests during an event in accordance with an exemplary embodiment of the present invention; and

FIG. 4 is a flow chart of a method for providing event-related data of specific interest during an event using a conventional display at an event and without modification to the display in accordance with an exemplary embodiment of the present invention.

### DETAILED DESCRIPTION OF PREFERRED EMBODIMENTS

In the description which follows, like parts are marked throughout the specification and drawing with the same reference numerals, respectively. The drawing figures may not be to scale and certain components may be shown in generalized or schematic form and identified by commercial designations in the interest of clarity and conciseness.

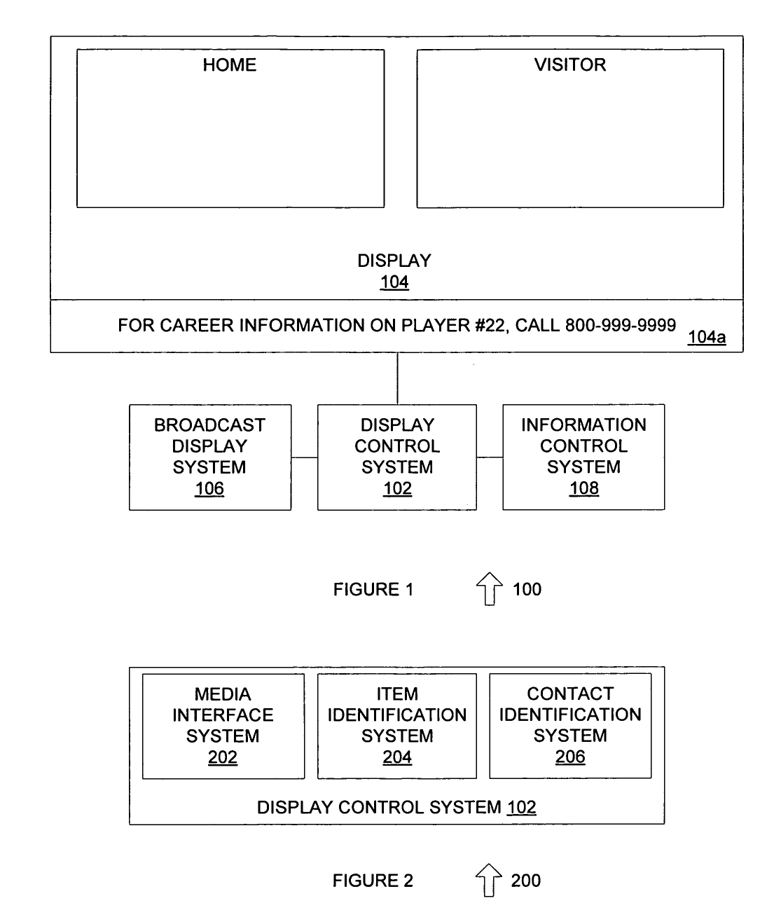

FIG. 1 is a diagram of a system 100 for displaying data on an event display that allows a user to obtain detail data during an event in accordance with an exemplary embodiment of the present invention.

Display control system 102, broadcast display system 106, information control system 108 and other suitable systems can be implemented in hardware, software, or a suitable combination of hardware and software, and can each be one or more software systems operating on a general purpose processing platform. As used herein, a software system can include one or more objects, agents, threads, lines of code, subroutines, separate software applications, two or more lines of code or other suitable software structures operating in two or more software applications or on two or more processors, or other suitable software structures. In one exemplary embodiment, a software system can include one or more lines of code or other suitable software structures operating in a general purpose software application, such as an operating system, and one or more lines of code or other suitable software structures operating in a specific purpose software application. A hardware system can include an integrated circuit, a field-programmable gate array, an application specific integrated circuit, a digital signal processor with included firmware, or other suitable hardware systems.

Display control system 102 is coupled to display 104. As used herein, the term “couples” and its cognate terms such as “coupled” or “couple,” can include a physical connection (such as a wire, optical fiber, or a telecommunications medium), a virtual connection (such as through randomly assigned memory locations of a data memory device or a hypertext transfer protocol (HTTP) link), a logical connection (such as through one or more semiconductor devices in an integrated circuit), or other suitable connections.

Display control system 102 controls the display of items that a viewer can obtain additional data on, such as during a sporting event, a musical performance, or other suitable events. In one exemplary embodiment, display control system 102 allows spectators at a sporting event to receive usual and customary data for the event, such as scores, team names, game time, quarter, periods, downs, fouls, strikes, or other data, as well as data on players, coaches, teams, items, or other information that is related to the sporting event. In another exemplary embodiment, display control system 102 allows spectators at a musical event to receive usual and customary data for the event, such as translations of foreign language lyrics, close-up video images of the performers, and graphical images that are coordinated with the music, as well as data on performers, tours dates, audio and video recordings, or other information that is related to the musical event.

Display 104 can be a scoreboard or other suitable display, such as one that includes a programmable banner 104a or other suitable devices for displaying information that changes continuously over time, such as advertising information. In one exemplary embodiment, display 104 presents data to spectators at a sporting event to allow them to obtain information on players at the sporting event, such as by generating a banner advertisement that identifies the player that information is available for and contact information for how to obtain information on the player, such as a telephone number, Internet website, or other contact information. In another exemplary embodiment, the sponsors or manufacturers of an automobile at a NASCAR™ or boat race event, the maker of musical instruments at a musical performance, or other suitable information can be obtained.

Broadcast display system 106 can interface with radio, television, the Internet, the cellular telephone network, or other broadcast media to provide information that changes over time, such as contact information. In one exemplary embodiment, broadcast display system 106 presents data to persons watching a sporting event, a musical event, or other suitable events over a broadcast medium, such as radio, television or the Internet, to allow them to obtain information on items that are being used in the sporting event, such as by generating a banner advertisement, providing information to an announcer, or by otherwise providing information that identifies the item for which information is available and contact information for how to obtain information on the item, such as a telephone number, Internet website, or other contact information. In this exemplary embodiment, a person watching a televised broadcast of a car race can request information on where to obtain additional information on the types of cars that are being driven, and this information can then be provided to all viewers, thus reaching viewers who may not have been aware of the existence of such information, and who can benefit from knowing about the availability of the information. Likewise, viewers that have registered with a server or other suitable systems can receive telephone text messages, Internet instant messages, email messages, or other suitable messages that provide them with information about the event.

Information control system 108 coordinates information on items, such as by coordinating information received from various sources, by providing information that is received from a viewer to a source (such as corrected information on where a player went to school, what musical groups a musician has performed in, or other suitable data), announcing that information is available from a source, providing contact data for the information source, or in other suitable manners. Information control system 108 can also provide information to an item authentication and tracking system and perform other suitable functions.

In operation, system 100 allows viewers of an event to interactively obtain information about the event in a non-distracting manner, such as by providing a banner advertisement, a pop-up advertisement, a radio advertisement, a text message, or in other suitable manners. System 100 thus blends in with displays that would normally be present at such events, allows users to request information that would not normally be displayed, uses user information requests to determine what information to add to the display of system 100, and performs other useful and non-obvious functions.

FIG. 2 is a diagram of a system 200 for controlling an event display to allow a user to obtain detail data in accordance with an exemplary embodiment of the present invention. System 200 includes display control system 102, media interface system 202, item identification system 204, and contact identification system 206.

Media interface system 202 coordinates the provision of data to one or more media, such as a banner advertisement on a scoreboard, a banner advertisement on a television screen, a commercial on television or radio, an Internet banner or pop-up advertisement, or other suitable media. In one exemplary embodiment, media interface system 202 ensures that the media content being provided to different forms of advertising media has the same content, content suitable for that media, or other suitable content. For example, a banner advertisement on a visual media can sometimes be converted to an audio advertisement by text-to-speech conversion, but other times would result in a message that is nonsense. Likewise, a pop-up advertisement may include image data that cannot be converted into a format suitable for a banner or audio advertisement. Media interface system 202 coordinates the data that is provided to different types of media to ensure that the data is consistent and timely.

Item identification system 204 receives item identification data, such as from an authentication system, user input, or in other suitable manners, and provides it to other suitable systems. In one exemplary embodiment, item identification system 204 can receive item identification data from an authentication system that reads unique authentication data (such as radio frequency identification data or bar code data) and provides corresponding item identification data, such as item description data, minimum bid data, or other suitable data. In another exemplary embodiment, item identification system 204 can receive a query, such as an item identifier, and can interface with an inventory system, an item authentication system, or other suitable systems to determine whether the item is available for bidding, to obtain item information, or for other suitable purposes.

Contact identification system 206 provides contact data for persons seeking additional information. In one exemplary embodiment, contact identification system 206 can provide a telephone number, a website address, an email address, an instant message address, an item number, or other suitable contact data to allow a person to obtain additional information on the item.

In operation, system 200 coordinates the provision of data to one or more displays that are used to identify event-related data that may be of special interest to a small number of observers that is available in addition to the general event information that is of interest to most observers and that customarily provided on the display. System 200 can thus allow viewers to obtain information that is not of general interest to the audience, to provide feedback that can be used to select additional information for general display, and to otherwise interact with event display systems in novel and non-obvious manners.

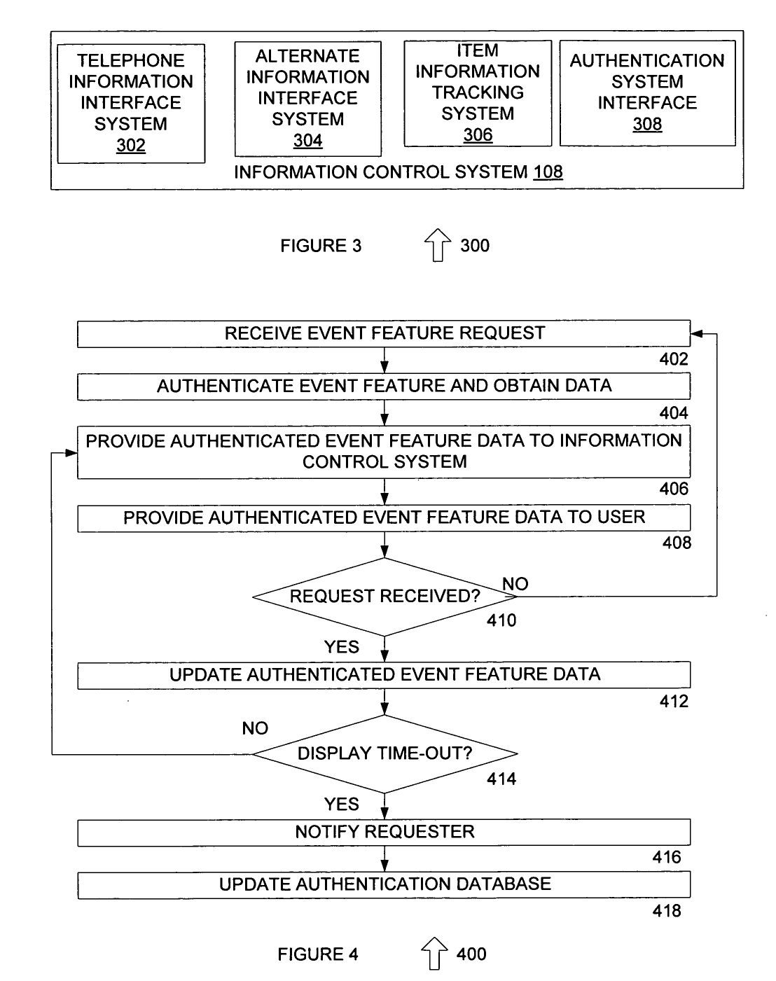

FIG. 3 is a diagram of a system 300 for controlling information requests during an event in accordance with an exemplary embodiment of the present invention.

System 300 includes information control system 108, telephone information interface system 302, alternate information interface system 304, item information tracking system 306, and authentication system interface 308, each of which can be implemented in hardware, software, or a suitable combination of hardware and software, and which can be one or more software systems operating on a general purpose processing platform.

Telephone information interface system 302 interfaces with the public switched telephone network, wireless telephone networks, radio channel networks, Internet telephony networks, private communications networks or other suitable media to allow persons to obtain information on players, musicians, teams, vehicles, gear, or other suitable items. In one exemplary embodiment, telephone information interface system 302 can generate audio prompts that prompt a caller to enter item identification data, to confirm the identity of the item, to notify the caller of the current item data, to prompt the caller to enter additional item data, or to perform other suitable functions.

Alternate information interface system 304 interfaces with other suitable media to allow persons to obtain information on players, musicians, teams, vehicles, gear, or other suitable items. In one exemplary embodiment, alternate information interface system 304 can generate audio prompts, video prompts, text messages, instant messages, prompts in a web page accessible through a web browser, or other suitable prompts that prompt a user to enter item identification data, to confirm the identity of the item, to notify the user of the current item data, to prompt the user to enter additional item data, or to perform other suitable functions.

Item information tracking system 306 tracks data on items, such as corrected historical information on a player, a director, an instrument being used in a musical performance, the availability of recordings by a musical performer, bids on items, or other suitable data, and interfaces with telephone information interface system 302, alternate information interface system 304, or other suitable systems to receive and provide information. In one exemplary embodiment, item information tracking system 306 can allow a viewer of an event to bid on an item being used in the event, such as a jersey being worn by a player, a helmet being worn by a player, a football, baseball, basketball, hockey puck, or other suitable items. Item information tracking system 306 can provide updated bid data to a bidder when a conflict has occurred, such as when a first bid is received from a first bidder at a first time and a second higher bid is received shortly after from a second bidder, so as to alert the first bidder that they have been outbid. Likewise, if the first bidder then places a subsequent bid that is higher than the second bid, the second bidder can be notified. When a winning bidder has been identified, item information tracking system 306 can provide information to the winning bidder that they have won (such as by voicemail, text message, email, by generating data for display 104, or in other suitable manners), can provide data to authentication system interface 308 to allow the ownership of the item to be reflected in the authentication records for tracking and authentication, to update historical data for the item, and for other suitable purposes.

Authentication system interface 308 provides item authentication data, such as data that confirms the identity of an item, the value of an item, the availability of an item or other suitable data. In one exemplary embodiment, authentication system interface 308 can provide data and receive a response from a user that provides additional data, corrected data, or other suitable data. In another exemplary embodiment, authentication system interface 308 receives winning bidder data, such as to associate a winning bidder for an item with the item in an authentication and tracking database.

In operation, system 300 allows event-related data of specific interest for items, persons, or other things associated with an event to be provided to observers by using existing event displays for various media to notify the observers of how to obtain the event-related data of specific interest, ensures that the information is consistent, and allows users to provide data and request additional data regarding the items.

FIG. 4 is a flow chart of a method 400 for providing event-related data of specific interest during an event using a conventional display at an event and without modification to the display in accordance with an exemplary embodiment of the present invention.

Method 400 begins at 402, where a feature request is received. In one exemplary embodiment, the feature request can be a request in response to a notice on an event display that event-related data of specific interest is available on a feature of an event, such as information on a player, information on a team, information on a piece of music being performed, information on a musical instrument being used, information on a vehicle being used in a race (car, boat, bicycle, kayak, motorcycle, or other suitable items), information on whether an item can be purchased, or other suitable information. For example, the event display can be a banner on a scoreboard, a free-standing banner advertisement device, a banner advertisement on a television screen or computer screen, a pop-up ad, an instant message, an email, or other suitable event displays or displays that are generated for a general observer during an event. The method then proceeds to 404.

At 404, the feature is authenticated and data can be obtained about the feature. For example, if the request is for information on a player that is not present at the event, the user can be informed that the feature was not authenticated—the player for which information was requested is not present at the event. In another exemplary embodiment, the feature can be authenticated by checking the feature against an authentication system, such as that disclosed in U.S. patent application Ser. No. 10/694,311, entitled “System and Method for Tracking Authenticated Items,” filed Oct. 27, 2003, publication US 2004-0088231-A1, which is hereby incorporated by reference for all purposes. In this exemplary embodiment, the authentication system can include data that uniquely identifies the item, such as from an identification device on the item. For example, an RFID tag, hologram tag, bar code tag, or other suitable device can be used to uniquely identify an item, and the item can be authenticated by reading data from the tag and comparing that data to data associated with the item in a database. This data can be checked to confirm that the item has been checked out for use during the event, to determine the current value for the item, to determine whether the event has ended, to determine whether bidding for the item is closed, or for other suitable purposes. For example, in one exemplary embodiment a jersey, helmet, or other item that is being worn by a player during a game can be bid on, with the end of the game or other suitable times being designated as the close of bidding. The method then proceeds to 406.

At 406, authenticated feature data is provided to an information control system, such as a system that provides data to a user on the authenticated feature. In one exemplary embodiment, the information control system can provide data about a player's career statistics, game statistics, or other event-related data. Likewise, information about the team's game or season statistics, musical recordings that are available for a musician, the current bid for an item of game-worn clothing, or other suitable data can be provided. The method then proceeds to 408 where the authenticated feature data is provided to the user. In one exemplary embodiment, the data can also be provided to a display control system, such as to notify viewers of the event of the current statistics for a player or team, of the current bid for an item of game-worn gear, or of other suitable data. The method then proceeds to 410.

At 410, it is determined whether a request has been received. If no request has been received, the method returns to 402 where a new feature request is awaited. Otherwise, the method proceeds to 412 where the authenticated feature data is updated. In one exemplary embodiment, a user can request to submit corrected or updated data for a feature, such as where the information provided for a player in the event is incorrect. The user can likewise request to receive additional information about an item, such as printed information about a vehicle being used in a race, printed or real-time information to order a musical instrument or piece of sporting gear, a request to bid on a piece of game-worn sporting gear, or other suitable requests. If the request is not amenable to immediate updating, such as where the information that has been provided must be verified, the request is flagged for further investigation. Otherwise, the request is updated, such as by updating the current bid for an item of game-worn sporting gear. The method then proceeds to 414.

At 414, it is determined whether a display time-out has occurred. In one exemplary embodiment, if the information has been purchased and is available for a predetermined period of time, it can be determined whether that period of time has elapsed. In another exemplary embodiment, where the feature is an item of game-worn or game-used sporting equipment, such as the baseball that was used to break a prior record, the bat that was used to hit the baseball, a game-worn jersey, or other item, it can be determined whether the end of the bidding period has occurred, such as whether the game is over. If it is determined that display time-out has not occurred, the method returns to 406. Otherwise, the method proceeds to 416.

At 416, the requester is notified of time out, such as by telephone, email, or in other suitable manners. In one exemplary embodiment, where the user has requested sports statistic data, the user can be notified that the game is over, that the period for accessing the data is over, or that the user's right to access the data has otherwise been terminated. In another exemplary embodiment, where the user has been bidding on an item, such as equipment or game-worn gear, the winning bidder can be notified. Other suitable processes or procedures can also or alternatively be used. The method then proceeds to 418.

At 418, the authentication database is updated, such as by confirming the information that has been provided by the user, by associating the name of the user with the item that has been won, by storing score data from the event, audiovisual data from the event, or storing other suitable data or performing other suitable processes.

In operation, method 400 allows attendees at or viewers of a live event to receive event-related data of specific interest that would not normally be displayed by the event display. Method 400 thus allows observers to interactively participate with the event in a manner not known or suggested by the prior art.

Although exemplary embodiments of a system and method of the present invention have been described in detail herein, those skilled in the art will also recognize that various substitutions and modifications can be made to the systems and methods without departing from the scope and spirit of the appended claims.

What is claimed is:

1. A system for displaying information to allow an observer at an event to obtain event-related data of specific interest using a pre-existing event general purpose display, comprising:
an information control system receiving contact information, formatting the contact information, and providing the contact information to the pre-existing event display to allow the observer seeking the event-related data of specific interest to contact the information control system;
a display control system receiving the contact information and providing the contact information to the general purpose display; and
an information interface system establishing a communications channel with the observer, retrieving requested event-related data of specific interest from a data source, formatting the requested event-related data of specific interest for transmission to the observer, and transmitting the event-related data of specific interest to the observer.

2. The system of claim 1 wherein the information interface system comprises a telephone information interface system providing the event-related data of specific interest through one or more audio prompts.

3. The system of claim 1 wherein the information interface system comprises an alternate information interface system providing the event-related data of specific interest in response to one or more of the group comprising email messages, instant messages, web browser prompts, and video prompts.

4. The system of claim 1 wherein the information interface system further comprises an item information tracking system updating item data in response to data entered by the user in response to the event-related data of specific interest.

5. The system of claim 1 wherein the information interface system further comprises an authentication system interface providing item authentication update data in response to data entered by the user in response to the event-related data of specific interest.

6. The system of claim 1 wherein the display control system further comprises a media interface system formatting the contact information for each of a plurality of pre-existing event displays.

7. The system of claim 1 wherein the display control system further comprises a contact identification system receiving the contact data from a predetermined source and providing the contact data to the display control system.

8. The system of claim 7 wherein the display control system further comprises an item identification system receiving the contact identification system, retrieving item identification data from a predetermined source and providing the item identification data to the display control system.

9. A method for displaying information to allow an observer at an event to obtain event-related data of specific interest using a pre-existing event general purpose display, comprising:
receiving a request to display contact information for observers seeking event-related data of specific interest;
selecting a display mechanism of the pre-existing event display;
formatting the contact information for display using the display mechanism of the pre-existing event display;
transmitting the formatted contact information to the display mechanism;
receiving a request from an observer for the event-related data of specific interest;
retrieving the requested event-related data of specific interest from a data source;
formatting the requested event-related data of specific interest for transmission to the user; and
transmitting the requested event-related data of specific interest to the user.

10. The method of claim 9 wherein selecting the display mechanism of the pre-existing event display, formatting the contact information for display using the display mechanism of the pre-existing event display and transmitting the formatted contact information to the display mechanism comprises:
selecting a plurality of display mechanisms of a plurality of pre-existing event displays;
formatting the contact information for display using the plurality of display mechanism of the plurality of pre-existing event displays; and
transmitting the formatted contact information to the plurality of display mechanisms.

11. The method of claim 9 wherein transmitting the formatted contact information to the display mechanism comprises transmitting the formatted contact information to a banner display on a scoreboard.

12. The method of claim 9 wherein transmitting the formatted contact information to the display mechanism comprises transmitting the formatted contact information to a banner display on a television screen.

13. The method of claim 9 wherein receiving a request from an observer for the event-related data of specific interest comprises receiving a response to a telephone audio prompt.

14. The method of claim 9 further comprising:
receiving response data from the user in response to the requested event-related data of specific interest; and
updating a database with the response data.
